(19) United States
(12) Patent Application Publication
(10) Pub. No.: US 2005/0258019 A1
(43) Pub. Date: Nov. 24, 2005

(54) Method and apparatus for moving objects

(76) Inventor: Todd J. Tiberi, New York, NY (US)

Correspondence Address: TODD TIBERI, APT. 4-F, 227 MULBERRY ST., NEW YORK, NY, 10012, US

(21) Appl. No.: 10/848,727

(22) Filed: May 20, 2004

(51) Int. Cl. B65G 15/42

(52) U.S. Cl. 198/867.11; 198/803.14

(57) ABSTRACT

This invention relates generally to an improved method for moving objects along a conveyor belt where it is desirable that objects are placed in containers permanently positioned on said belt.

The present invention relates to a method and apparatus for moving objects, including moving objects on a belt.

### BACKGROUND OF THE INVENTION

Airport and other travel-related security have become increasingly important in society. Accordingly, enhanced vigilance by airport and other travel-related security personnel has become the norm in airports and other travel points worldwide. For example, an important component of airport security is to require passengers to pass through a metal detector and for passengers to send their carry-on items through a metal detector, x-ray machine, or the like. The purpose is to reduce the probability that a passenger will be able to bring onto the airplane a dangerous weapon, explosive device, or the like.

While these security measures are believed to be helpful in making travel more safe, they can also be inconvenient for travelers and present logistical difficulties for airport security personnel. For example, travelers usually are required to place all manner of objects onto a conveyor belt that moves the objects through a metal detector, x-ray machine, or the like, before a traveler is allowed to proceed to the airplane gate. Conveyor belts are well-known in the art and typically consist of a belt that moves in a repeatable pattern and can be stopped, reversed, or perhaps have the speed of its movement altered. The mechanical operation of conveyor belts is well-known in the art. Conveyor belts can be made of various suitable materials, including rubber, plastic, or other polymers.

Objects placed on conveyor belts may include bags, suitcases, backpacks, keys, cellphones, shoes, coats, laptop computers, coins, or any other type of object. Typically, some of these objects are not placed directly on the conveyor belt but rather are placed in containers such as plastic bowls or trays, and these containers are then placed on the belt. These containers thus pass through the metal detector on a belt and arrive at the end of the belt. The containers accumulate at the far end of the belt, causing inconvenience and logistical difficulties. At the airport screening area, there is limited space for the storage of the containers. And having an unlimited supply of containers at the front of the detector is neither cost-effective nor practical. In addition, travelers often have to wait for additional containers to be brought to the front of the conveyor belt by security personnel and take time to pull apart stacked containers.

Therefore, the containers must be “recycled,” that is, they are returned to the front of the detector after passing through it to enable subsequent travelers to place objects into the containers. An inefficiency of this system is that the containers must be brought to the front by hand, usually by airport security personnel. This task is inefficient, time-consuming, and, significantly, distracts airport security personnel from more important responsibilities, such as ensuring that prohibited objects are not brought onboard airplanes. The present invention overcomes these disadvantages.

### SUMMARY OF THE INVENTION

The present invention includes an improved conveyor belt apparatus, and method for moving objects, that eliminate the need for separate, stand-alone containers. Such an apparatus and method should reduce the need for travel security personnel to devote time and attention to collecting containers and placing them in front of metal detectors. Often, travelers must wait for additional containers to be brought to the front of the conveyor line before placing objects on the conveyor. In addition, they often must wait for the travelers in front of them to place objects in containers before placing their own objects in containers as they become available. The present invention should help reduce these inconveniences and also reduce the time that air travelers spend in passing through security lines, resulting in a decrease in annoyance, and even emotional outbursts from travelers. The present invention should also significantly reduce the distraction of security personnel who must devote substantial time to collecting and replacing stand-alone containers.

The considerable expense and inconvenience due to stand-alone containers also should be avoided. Potential advantages include greater attention by security personnel to matters more directly related to travel security, reduced cost of security measures, and increased passenger convenience and contentment. Of course, one skilled in the art will understand that the inventions can be used in all manner of activities involving conveying objects, including but not limited to security screening at railroad stations, subways stations, court houses, sporting events, office buildings, or any other location where objects are moved on conveyor belts. One skilled in the art will further understand that the inventions can be used for the movement of any other objects, such as agriculture products, vegetables, fruits, factory parts, assembly lines, grocery store items, or the like—regardless of whether such objects are to be screened or otherwise evaluated.

### BRIEF DESCRIPTION OF THE DRAWINGS

FIG. 1 is a plan view showing one embodiment of the invention where a containing means configuration is shown on a conveyor belt as a sloped configuration. For clarity, the conveyor belt is shown in simplified format, and a detecting means or other apparatus that is capable of being used in conjunction with the invention is not shown in this or the other Figures.

FIG. 2 is a plan view showing one embodiment of the invention where a containing means configuration is shown on a conveyor belt as a stand-alone wall configuration.

FIG. 3 is a plan view showing one embodiment of the invention where a containing means configuration is shown on a conveyor belt as having a plurality of sides.

FIG. 4 is a plan view showing one embodiment of the invention where a containing means configuration is shown on a conveyor belt as depressions or sunken areas on a conveyor belt.

FIG. 5 is a perspective view showing one embodiment of the invention where a containing means configuration is shown from above on a conveyor belt as walls capable of being used as dividers between portions of the conveyor belt.

FIG. 6 is a perspective view showing one embodiment of the invention where a containing means configuration is shown from above on a conveyor belt as walls arranged such that they are capable of ejecting objects into separated areas.

FIG. 7 is a plan view showing one embodiment of the invention where a containing means configuration includes a flap that is capable of enhancing the ability of the containing means to eject objects.

FIG. 8 is a plan view showing one embodiment of the invention where a containing means configuration is shown on a conveyor belt as a plurality of walls connected by concave walls.

FIG. 9 is a plan view showing one embodiment of the invention where a containing means configuration is shown on a conveyor belt as stand-alone walls.

### DETAILED DESCRIPTION OF THE INVENTION

The present invention relates to an improved system and method for moving objects along conveyor belts, or other transporting mechanisms, such as conveyor belts commonly used at airport or other security screening areas. The invention includes a belt or belt-like apparatus having walls or other containing means capable of containing objects. The containing means is permanently positioned on, or, optionally, part of the belt. One skilled in the art should understand that the term “permanently positioned on said belt” is defined by the inventor to mean that the containing means is attached or integrally formed with the belt but that it can be capable of being removed for cleaning, repair, replacement, maintenance, or adjustment of the dimensions or area covered by the containing means. Thus “permanently positioned on said belt” includes embodiments where the container means is attached to the belt, and also includes embodiments where the container means is seamlessly formed of the same material as the belt, for example, where the container means is positioned on the top of the belt or where the container means is in the form of a depression within the belt.

The containing means can be made of any material capable of containing objects, such as rubber, plastics, polymers, or any other suitable materials well-known in the art. Optionally, the material can be capable of substantially maintaining its shape while a weight or other stress is applied to it. In the alternative, the material can be capable of collapsing while a weight or other stress is applied to it and be capable of substantially resuming its shape after the weight or stress is removed.

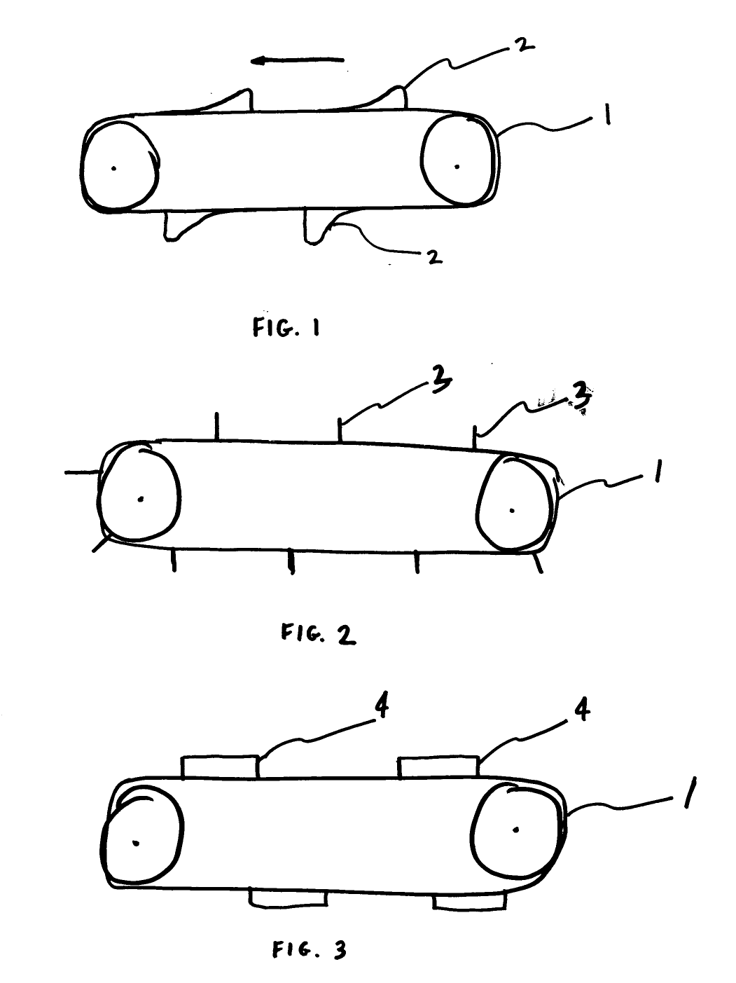

One illustrative example is where the conveyor belt is used at an airport security screening area. For example, in FIG. 1, objects (not shown) are placed within the containing means 2 on a conveyor belt 1. The containing means 2 may be attached to a belt by, for example, glue, staples, stitching, or any other means of attachment. In the alternative containing means 2 may be integral with the belt, for example, it may be seamlessly formed from the same material as the belt. The objects move along the conveyor belt within the container means 2 and pass by the security detector (not shown) unobstructed by light shields, curtains, or other impediments. At the end of the belt, the objects are either removed from the belt by travelers, airport security personnel or, optionally, are ejected onto a surface adjacent to the conveyor belt. In one preferred embodiment, the containing means is large enough to contain shoes, laptop computers, coats, or the like.

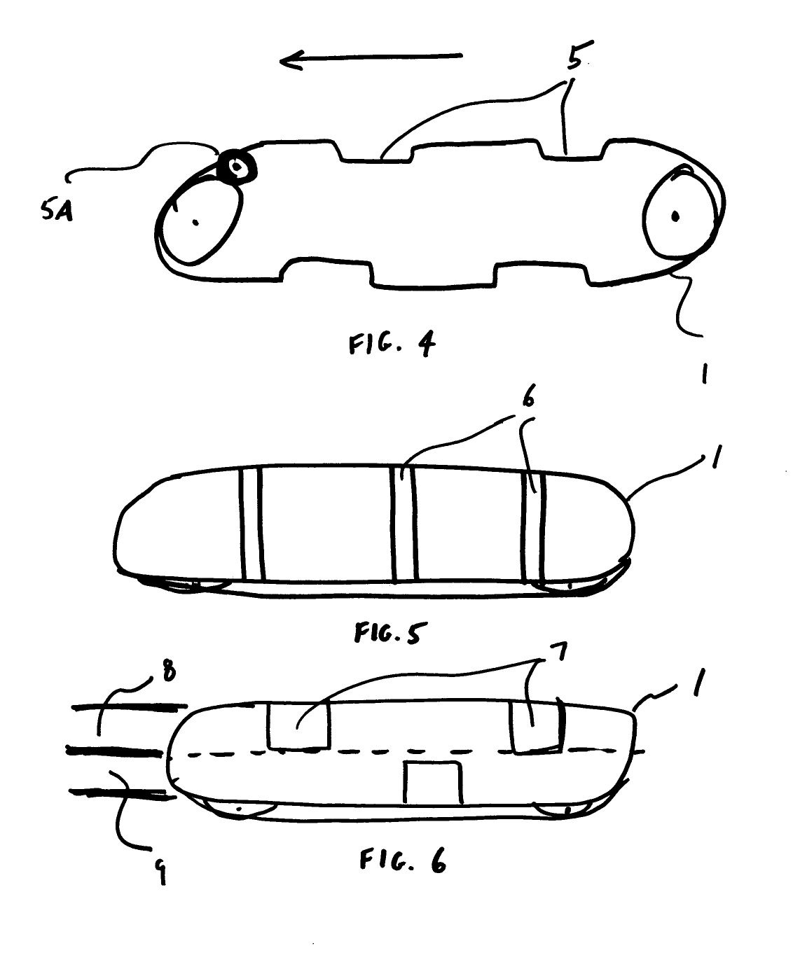

In another preferred embodiment, the containing means can be a recess or depressed area permainent positioned on the belt that is capable of containing objects, such as shown by depressions 5 in FIG. 4. Depressions 5 may be attached to a belt by, for example, glue, staples, stitching, or any other means of attachment. In the alternative, depressions 5 may be integral with the belt, for example, they may be seamlessly formed from the same material as the belt. In either preferred embodiment, flattener 5A may be included to cause depressions 5 to become less depressed when rolling over flattener 5A. In this regard, objects within depressions 5 may be ejected onto an adjacent surface.

After objects are placed on or within the containing means, they move along the conveyor belt and are examined, x-rayed, weighed, priced, scanned, or evaluated in any other number of ways or, optionally, not evaluated at all. The containing means can be designed such that the walls comprising such containing means are collapsible. Collapsible materials are well-known in the art, and include rubber, plastic, other polymers, and a host of any other flexible or malleable materials, or the like. With this feature, in some conveyor belt configurations, the walls are able to repeat their rotational cycle around the conveyor belt without becoming stuck or otherwise significantly hindering the movement of the belt. For example, the walls would not become stuck at the point where a surface adjacent to the end of the belt is found, such as at the end of the conveyor belt. Of course, the containing means need not be collapsible if the belt is spaced at a distance from an adjacent surface greater than the height of the walls of the containing means.

By the time the containing means returns to the front of the conveyor the walls, if made of an optional collapsible material, it may be capable of substantially returning to its original position and become again suitable to contain objects. Another aspect of the optionally collapsible containing means is that a traveler need not wait to position particular objects, for example large bags or other objects not necessary to place in the container means, onto the belt between the walls. In other words, objects that are not intended to be placed in a container can be placed anywhere on the belt without regard to whether such objects are placed near or on top of the container means.

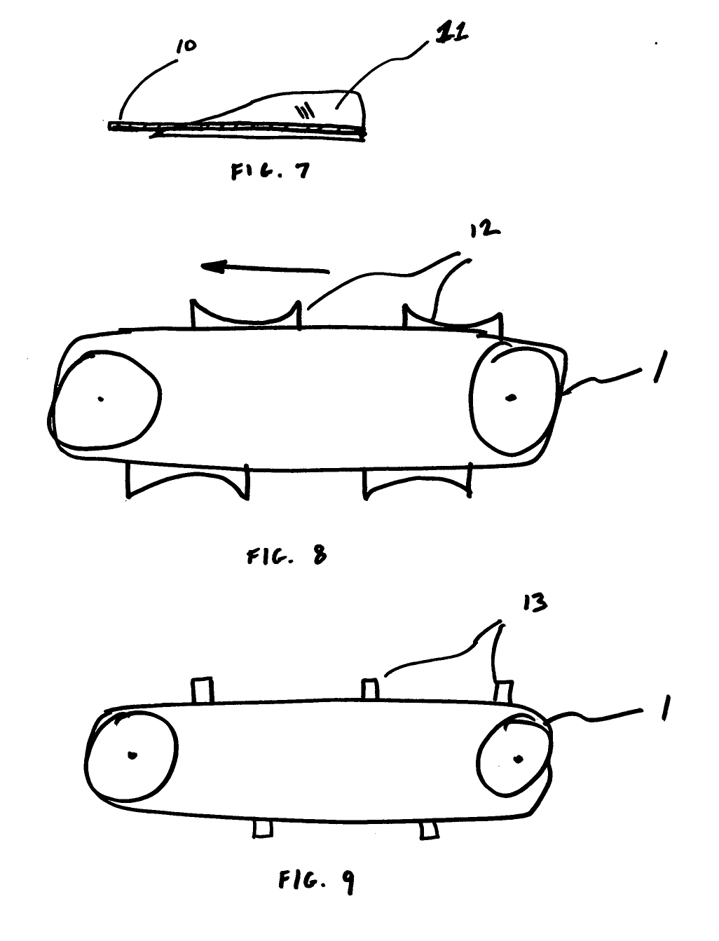

In another aspect of a preferred embodiment, the containing means is designed such that whatever objects are inside the containing means can be ejected onto a surface at the end of the conveyor belt. One such configuration is illustrated in FIG. 7, which shows a flexible flap 10 connected to the back of containing means 11. When containing means 11 reaches the end of a conveyor belt, flap 10 moves forward and temporarily catches on a surface adjacent to the belt. Containing means 11 continues in the belt's circular direction. An object within containing means 11 would therefore be ejected onto the adjacent surface by action of the continued movement of containing means 11. Flap 10 would eventually resume travel in the belt's circular direction after the object has been ejected. The process can be repeated on the next revolution of the belt. Of course, this configuration can be employed with any embodiment of the invention and is not limited to the configuration shown in FIG. 7.

In this aspect, the traveler need not wait at the end of the conveyor for the object, and the belt can continue to move rather than stop until the traveler or another individual has retrieved the object stored inside the containing means. In still another aspect of a preferred embodiment, as shown in, for example, FIG. 6, a containing means 7 can be designed and/or arranged in such a way that the object is ejected into a plurality of predetermined compartments or slots 8, 9 found on a surface at the end of the conveyor belt. For example, one containing means on the belt can be designed or positioned such that it ejects its object into a slot on the left of the surface at the end of the conveyor belt, while another containing means can be designed or positioned such that it ejects its object into a slot on the right of the surface. Of course, any number of compartments and slots, with corresponding container means of any suitable configuration, is possible. This preferred embodiment can be capable of therefore enhancing the separation of a traveler or travelers' various objects.

Other embodiments and aspects of the invention are shown in the remaining Figures, which are intended only to be illustrative and not limiting the invention in any way. The containing means can be of any suitable dimensions to contain objects. For example, it can be the width of the conveyor belt on which it is permanently positioned. While the invention is suitable for airport screening devices, it should be apparent to one skilled in the art that it can be used for any other conveyor belt applications, such as those used at train stations, court houses, schools, embassies, factories, farms, grocery stores, or any other location where objects are placed on belts and it is desirable for them to be placed in non-stand-alone containers, whether or not the objects are screened or otherwise evaluated for security purposes. In addition, one skilled in the art should understand that the invention is not limited to the configurations and aspects shown herein and that a multitude of variations and modifications of the express disclosures herein are within the scope of the invention.

1. A conveyor belt, comprising:
one or more container means permanently positioned on said belt;
said container means having one or more sides capable of containing one or more objects.

2. The belt in claim 1 wherein said sides are capable of collapsing without permanent deformation when a stress is applied to said sides.

3. The belt in claim 1 wherein said container means is capable of ejecting objects contained therein onto an adjacent surface at or near the end of said belt.

4. The belt in claim 3 wherein said objects are ejected into separate compartments onto an adjacent surface at or near the end of said belt.

5. The belt in claim 3 also comprising a flattener positioned such that where said container means is a depression, said depression rolls over said flattener and becomes less flat at or near the end of said belt.

6. A method for moving objects, comprising:
providing a conveyor belt; and
providing one or more container means permanently positioned on said belt, wherein said container means has one or more sides capable of containing one or more objects.

7. The method in claim 6 wherein said sides are capable of collapsing without permanent deformation when a stress is applied to said sides.

8. The method in claim 6 wherein said container means is capable of ejecting objects contained therein onto an adjacent surface at or near the end of said belt.

9. The method in claim 8 wherein said objects are ejected into separate compartments onto an adjacent surface at or near the end of said belt.

10. The method in claim 8 also comprising providing a flattener positioned such that where said container means is a depression, said depression rolls over said flattener and becomes less flat at or near the end of said belt.
